(19) United States
(12) Patent Application Publication
(10) Pub. No.: US 2007/0198693 A1
(43) Pub. Date: Aug. 23, 2007

(54) Processing of consecutive inquiries from an external computer in a computer system comprising at least one first computer and one second computer

(76) Inventor: Daniel Scheibli, Palo Alto, CA (US)

Correspondence Address: SAP / FINNEGAN, HENDERSON LLP, 901 NEW YORK AVENUE, NW, WASHINGTON, DC, 20001-4413, US

(21) Appl. No.: 10/574,641

(22) PCT Filed: Sep. 6, 2004
(86) PCT No.: PCT/EP04/52044

§ 371 Date: Dec. 14, 2006

(30) Foreign Application Priority Data
Oct. 6, 2003 (DE) 103 46 303.8

(51) Int. Cl. G06F 15/173

(52) U.S. Cl. 709/224

(57) ABSTRACT

In a computer system comprising a first computer (A) and a second computer (B) consecutive inquiries (311, 312) from an external computer (E) are processed by the observation (410) of the processing time (T1) that the first computer (A) requires for processing a first inquiry (311) of the external computer (E), and rerouting (420) of a second inquiry (312) from the first computer (A) to the second computer (B) if the processing time (T1) exceeds a standard time (TNORM).

### TECHNICAL FIELD

The invention relates to computer systems, computer programs and computer-implemented methods in general and in particular to a system, a program and a method for processing consecutive inquiries of an external computer in a computer system comprising at least one first computer and one second computer.

Computer systems with a large number of individual computers that cooperate with one another are known by the term “cluster”. The systems execute applications, such as business applications. The applications are distributed among services which are executed in each case by the individual computers in the cluster.

Management programs are used to allocate services to the computers of the cluster. These management programs make use of standard techniques, such as heartbeat and messaging, for example for starting or pausing a service or for querying the on-off status of this service.

In a system with an application in the Customer Relationship Management (CRM) sector, there are, for example, services such as (1) reading customer data from a database, (2) transmitting the data to the customers (for example via the internet), (3) forwarding customer telephone calls to an adviser in a call centre.

So disruptions during the working process of individual services do not have an effect on the entire application, the management program is also used to transmit services from a computer that has failed to an operable computer. Functions of this type are known inter alia by the term fail over.

The object of the invention is to achieve improved operating methods, management programs and computer systems in which disruptions are detected as soon as they emerge and are limited in their effect.

The objects are achieved according to the invention by methods, programs and systems according to the main claims. Advantageous embodiments are the subject of the sub-claims.

### BRIEF DESCRIPTION OF DRAWINGS

FIG. 1 shows an overview of a simplified computer system comprising two computers A and B which behave according to the invention,

FIG. 2 shows a flow chart of a method according to the invention,

FIG. 3 shows details of the observation method step in an exemplary embodiment,

FIG. 4 shows details of the rerouting method step in an exemplary embodiment,

FIG. 5 shows an application example of the invention in conjunction with an application in the Customer Relationship Management (CRM) sector, the application corresponding via a web service with an external computer,

FIG. 6 shows an application example of the invention from the perspective of using blade computers,

FIG. 7 shows a computer system in which the invention can be implemented.

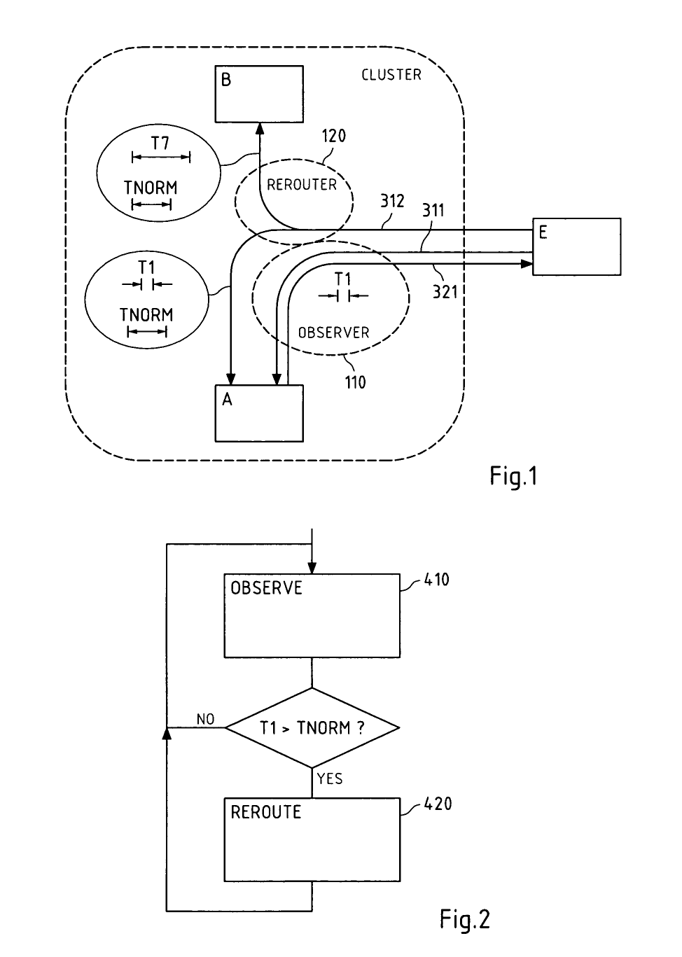

The following description briefly introduces FIG. 1 to 5, then describes further details in conjunction, gives implementation tips for hardware and ends with a list of reference numerals.

FIG. 1 shows an overview of a simplified computer system which behaves according to the invention.

The left-hand side of the figure shows the computer system A, B (cluster) with, for example, N=2 computers A and B. N can be selected as desired so as to be higher. The computers A and B are also called servers. The management program is located on A, on B, on A and B or on a third computer. The management program is shown simplified in the figure in the centre between A and B. The management program has the two modules observer 110 and rerouter 120.

The right-hand side of the figure shows the computer E which as an external computer is alien to the system in relation to A and B.

The arrows show the communication between the computers A, B and E. Arrows 311 and 312 show consecutive querying by the external computer E of system A, B. Arrow 321 shows the response of computer A to computer E. The person skilled in the art can carry out the communication as desired, for example messaging via a network or a bus within the system (A, B), or via internet protocols outside of the system (for example A with E, B with E).

The measuring lines indicate time intervals (for example T1, TNORM) and in their magnitudes with respect to each other are representative of the time relationships: T1 for example is greater than TNORM or less then TNORM (“>” or “<”).

The method according to the invention comprises the following steps: observation of the processing time T1 that computer A requires for processing the first inquiry 311 of the external computer E, and rerouting of the second inquiry 312 from computer A to computer B if the processing time T1 exceeds a standard time TNORM.

The present invention is thus a complement to cluster operation with conventional management programs. It is advantageous that the effect outward of computer A is used as a decision criterion for cluster-internal processes (such as rerouting). In other words, the system A, B has the function vis-à-vis the external computer E of an application provider and balances the internal load depending on the quality of the application with respect to the external computer E.

FIG. 2 shows a flow chart of a method according to the invention 400 with said steps of observation 410 and rerouting 420. Step 420 is executed under the condition of time-out, for example T1>TNORM. The loop arrows symbolise the preferred continuous duration of application of the method.

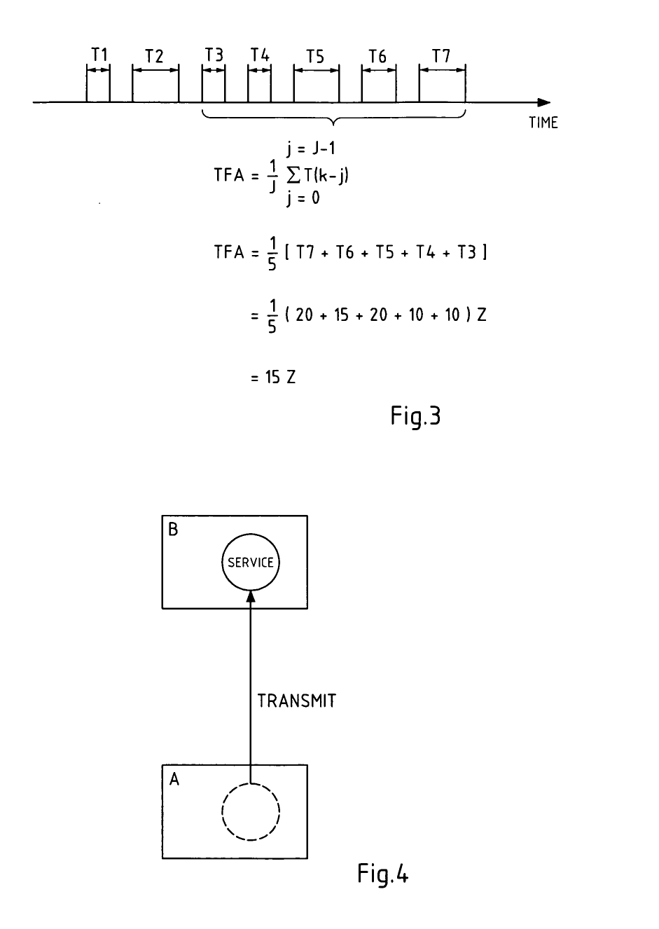

FIG. 3 shows details of the method step observation 410 in an exemplary embodiment, the processing times of consecutive inquiries being taken into account.

As shown by way of example in the figure the times for consecutive inquiries (here T1 to T7) have been determined and captured numerically in a time unit Z. The following are used by way of example as the time unit Z: second, millisecond or any other legitimate time unit. Countable events such as computer clocks may also be used.

The time between the processing of operations (inquiry/response) is irrelevant. For example after the 7^{th} measurement (T7 known, index k=7) the floating average TFA for a stipulated number of J=5 measured values is determined. It is advantageous in this case that occasional incidences of exceeding of TNORM do not immediately lead to rerouting.

Alternatively, the number of time-outs within a measuring interval is assessed as a reason for rerouting. The standard time is then fixed relative to a series of measurements, for example exceeding of 15 Z within J=5 measurements is allowed only once.

In an example there were two incidences of exceeding: at T5 (20 Z) and at T7 (likewise 20 Z). Rerouting should have been initiated in this case.

FIG. 4 shows details of the method step rerouting 420 in an exemplary embodiment. A service which can answer the inquiry (for example 312) is executable on the computer (for example B), in real-time with the rerouting 420.

For example, rerouting 420 takes place in that a service of computer A is transferred to computer B.

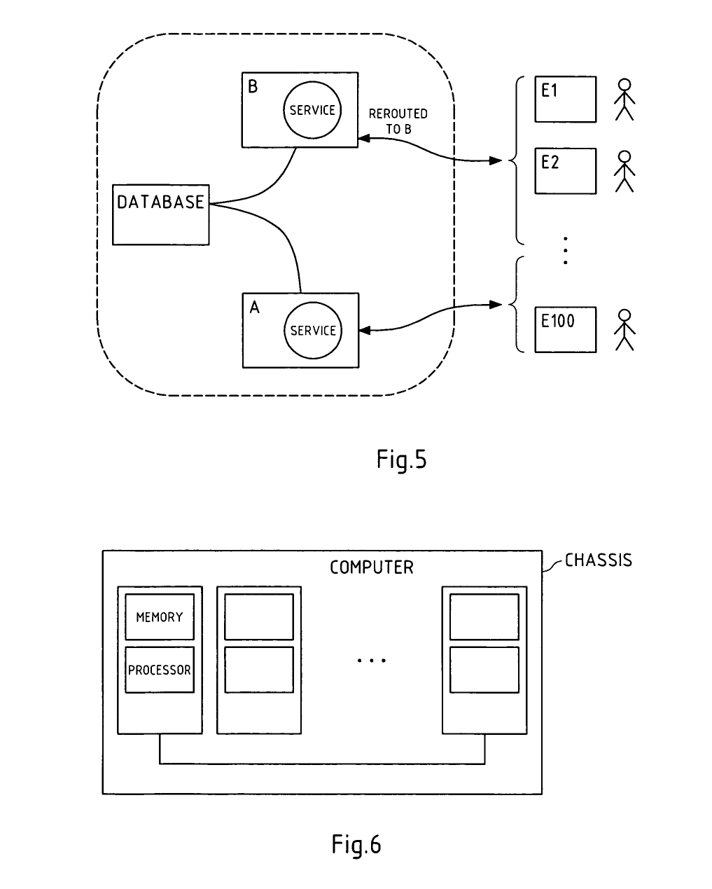

Rerouting 420 takes place on a computer which is already part of the cluster (such as B), or on a computer which is incorporated into the cluster for this purpose. If the service accesses a resource outside A and B (such as databases), the addresses of the resource are transferred from A to B. It is irrelevant whether the service remains on computer A (cf. example in FIG. 5) or is removed from A.

FIG. 5 shows an embodiment of the invention in conjunction with an operational application. Applications of this type are offered inter alia by SAP Aktiengesellschaft, Walldorf, for example those called SAP R/3 or SAP NetWeaver, with specialisations such as Customer Relationship Management (CRM).

Computer A for example executes an internet service which supplies a large number of external computers E (here E1 to E100) of customers with catalogue images which are stored in a database. The database may be inside or outside the cluster. Occasionally many customers make inquires at the same time and thereby overload computer A. The invention allows bottlenecks of this type to be recognised and eliminated. In the event of time-outs individual customer inquiries are rerouted to computer B, so both A and B execute this service.

Details with respect to FIGS. 1 to 5 follow, starting with explanations of the times.

It is advantageous to relate the start of processing time T1 to receipt of the first inquiry 311 by computer A. Accordingly it is advantageous to relate the end of processing time T1 to the sending of a response 321 to computer E. The running time of the response (computer A to computer E) does not have to be taken into account.

As different computers with different configuration may be present in a system, adaptation of the standard times to the respective computers is advantageous. For example the standard time (TNORM) would be dependent on the configuration of the first computer (A).

The person skilled in the art can select TNORM according to both the type of inquiry and according to the type of response. For example in a service “transferring data to customers” (see introduction), processing of large quantities of data can be entitled to more time than processing of small quantities of data.

The person skilled in the art can implement the processing quality in general as a decision criterion. For example the processing time T1 can be determined relative to a quantity of data, indicated in units of measurement, for example unit of time per quantity of data (for example seconds per megabyte). A reciprocal definition of data quantity per time is also possible. A definition of this type is advantageous for example for services for ascertaining entries in database tables.

The use of two times (TNORM and TMAX) is advantageous. In this case processing of inquiry 311 is transmitted 420 to computer B if, after expiry of a maximum time (TMAX), processing by computer A persists (“time-out”). Whereas when TNORM is exceeded only subsequent inquiries (in other words for example 312) are transmitted, when TMAX is exceeded failure of computer A is to be assumed. The cluster management can react accordingly. The person skilled in the art can also apply the time adjustments to the maximum time TMAX: for example TNORM and TMAX can be adapted depending on the service, for example longer times for background services but shorter times for customer-critical services (cf. FIG. 5).

The description of the details continues with explanations relating to observation and rerouting.

As computer A is still operating (albeit more slowly) rerouting 420 does not have to take place immediately after a time-out has been ascertained. Rerouting may be preceded by an availability test. This test may contain the observation step with test data or according to conventional yes-no querying. If there is no suitable computer available the management program can cause an additional computer to be incorporated into the system. The additional inquiry is processed if a suitable computer has been incorporated into the computer system.

The management program 110/120 may also be implemented by the first computer (A), the second computer (B) or a third computer. The modules may be distributed in the system. It is advantageous to execute the management program 110/120 within the system.

Implementation tips for hardware follow. The invention is suitable for use with computers which are similar, for example with respect to manufacturer, number of processors, operating system (for example a system with peer-to-peer architecture, cf. FIG. 6).

However, it is also possible to use different computers. Rerouting to computers with improved power, for example with a faster processor or a larger number of processors, also brings advantages. It is to be expected that the processing time will be reduced when processing the second inquiry using the more powerful computer.

FIG. 6 shows an application example of the invention from the perspective of using blade computers. The computers have conventional elements, such as processors, memories (for example semi-conductor memories, hard drives), buses, etc. The computers may be constructed using blade-server technology. In this case processors and memories are arranged on a blade. A plurality of cards plug in one chassis and are centrally supplied with current. The present invention is particularly suitable for this technology as individual computers (for example with database servers) can be added or removed during operation and the method according to the invention automatically reacts to such changes.

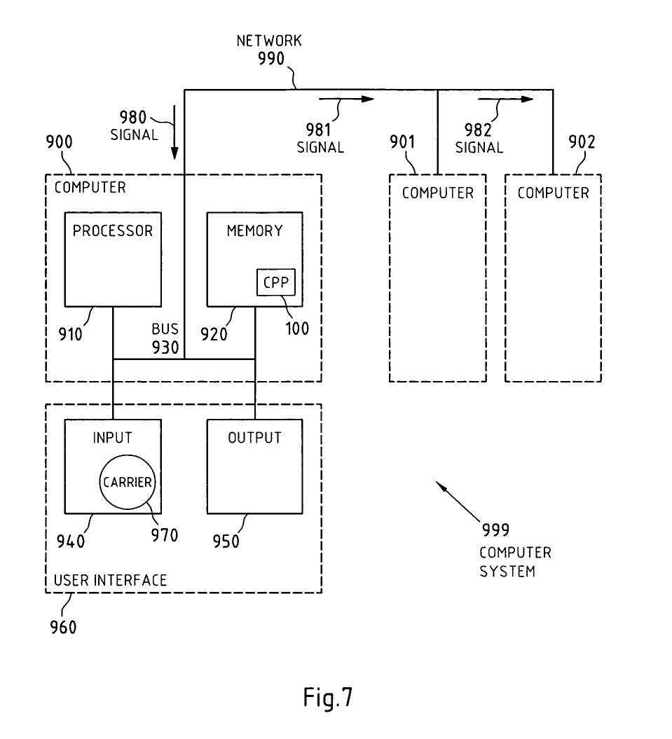

FIG. 7 shows a computer system, in which the invention can be implemented, as a simplified block diagram of a computer network system 999 with a large number of computers (or 90q, q=0 to Q 1, Q as desired).

The computers 900 to 902 are connected via a network 990. Computer 900 comprises a processor 910, a memory 920, a bus 930 and optionally an input device 940 and an output device 950 (input and output devices produce the user interface 960). The invention exists as a computer program product (CPP) 100 (or 10q, wherein q=0 to Q 1, Q as desired), as a program carrier 970 and as a program signal 980. These components will be designated the program hereinafter.

The elements 100 and 910 to 980 of the computer 900 generalise the corresponding elements 10q and 91q to 98q (shown for q=0 in computer 90q).

Computer 900 is, by way of example, a conventional personal computer (PC), a multiprocessor computer, a mainframe computer, a portable or a stationary PC or the like.

The processor 910 is, by way of example, a central processing unit (CPU), a microcontroller (MCU) or a digital signal processor (DSP).

The memory 920 symbolises elements which store data and commands either temporarily or permanently. Although for the purpose of better understanding the memory 920 is shown as part of the computer 900, the memory function in the network 990 can also be implemented at another location, for example in computers 901/902 or in the processor 910 itself (for example cache, register). The memory 920 can be a read only memory (ROM), a random access memory (RAM) or a memory with other access options. The memory 920 is physically implemented on a computer-readable data carrier, for example on:

(a) a magnetic data carrier (hard drive, disk, magnetic tape),

(b) an optical data carrier (CDROM, DVD),

(c) a semi-conductor data carrier (DRAM, SRAM, EPROM, EEPROM) or on any other desired medium (for example paper).

The memory 920 is optionally distributed over various media. Parts of the memory 920 can be provided so as to be permanent or replaceable. The computer 900 uses known means, such as disk drives or tape drives, for reading and writing.

The memory 920 stores support components, such as for example a BIOS (Basic Input Output System), an operating system (OS), a program library, a compiler, an interpreter or a text processing program. Support components are commercially available and can be installed on the computer 900 by experts. These components are not shown for the purpose of better understanding.

CPP 100 comprises program instructions and optionally data which inter alia cause the processor 910 to execute method steps 430 to 450 of the present invention. The method steps will be described in detail later. In other words, the computer program 100 defines the function of the computer 900 and the interaction thereof with the network system 999. Without intending a limitation here, CPP 100 may for example be in the form of a source code in any desired programming language and as a binary code in a compiled form. The person skilled in the art is capable of using CPP 100 in conjunction with any of the previously described support components (for example compiler, interpreter, operating system).

Although CPP 100 is shown stored in the memory 920, CPP 100 can also be stored at any other desired location. CPP 100 can also be stored on the data carrier 970.

The data carrier 970 is illustrated outside of the computer 900. To transmit CPP 100 to the computer 900 the data carrier 970 can be introduced into the input device 940. The data carrier 970 is implemented as any desired computer-readable data carrier, such as for example one of the previously described media (cf. memory 920). In general the data carrier 970 is a product which contains a computer-readable medium on which computer-readable program coding means are stored which are used to execute the method of the present invention. The program signal 980 may also contain CPP 100. The signal 980 is transmitted via the network 990 to the computer 900.

The detailed description of CPP 100, carrier 970 and signal 980 is to be applied to the data carriers 971/972 (not shown), to the program signal 981/982 and to the computer program product (CPP) 101/102 (not shown), which is executed by the processor 911/912 (not shown) in the computer 901/902.

The input device 940 represents a device which provides data and instructions for processing by the computer 900.

For example, the input device 940 is a keyboard, a pointing device (mouse, trackball, cursor arrow), microphone, joystick or scanner. Although the examples are all devices with human interaction, the device 940 can also manage without human interaction, such as for example a wireless receiver (for example by means of satellite or terrestrial aerials), a sensor (for example a thermometer), a counter (for example a unit counter in a factory). Input device 940 can also be used to read the data carrier 970.

The output device 950 represents a device which displays data and instructions that have already been processed. Examples of these are a monitor or another display (cathode ray tubes, flat screen, liquid crystal display, loudspeaker, printer, vibration alarm). Similar to the input device 940 the output device 950 communicates with the user but it can also communicate with other computers.

The input device 940 and the output device 950 can be combined in a single device. Both devices 940, 950 can optionally be provided.

The bus 930 and the network 990 represent logical and physical connections which transmit both commands and data signals. Connections within the computer 900 are conventionally called a bus 930; connections between the computers 900 to 902 are called a network 990. The devices 940 and 950 are connected to the computer 900 by the bus 930 (as shown) or, optionally, are connected via the network 990. The signals within the computer 900 are predominantly electrical signals whereas the signals in the network are electrical, magnetic and optical signals or may also be wireless radio signals.

Network environments (such as network 990) are conventional in offices, company-wide computer networks, intranets and in the Internet (i.e. the World Wide Web). The physical distance between the computers in the network is irrelevant. Network 990 can be a wireless or wired network. The following are listed as possible examples of implementations of the network 990: a local network (LAN), a Wide Area Network (WAN), an ISDN network, an infrared connection (IR), a radio connection, such as the Universal Mobile Telecommunication System (UMTS) or a satellite connection.

Transmission protocols and data formats are known. Examples of these are: TCP/IP (Transmission Control Protocol/Internet Protocol), HHTP (Hypertext Transfer Protocol), URL (Unique Resource Locator), HTML (Hypertext Markup Language), XML (Extensible Markup Language), WML (Wireless Application Markup Language), etc.

Interfaces for coupling the individual components are also known. For simplification the interfaces are not shown. An interface may, for example, be a serial interface, a parallel interface, a gameport, a universal serial bus (USB), an internal or an external modem, a graphics adapter or a soundcard.

### REFERENCE NUMERALS

100 computer program
110 observer
120 rerouter
311 first inquiry
312 second inquiry
321 response
400 method
410 observation step
420 rerouting step
9xx computer in general and its elements
A, B computers in the system
E; E1 to E100 computers outside of the system
J number of measured values
k index for further observations
N number of computers in the system
T1 observed processing time for the first inquiry
TFA floating average
TMAX maximum time
TNORM standard time
Z time unit

1. A method (400) for use in a computer system comprising at least one first computer (A) and one second computer (B), the system (A, B) for processing consecutive inquiries (311, 312) of an external computer (E), the method (400) comprising: observation (410) of the processing time (T1) that the first computer (A) requires for processing a first inquiry (311) of the external computer (E), and rerouting (420) of a second inquiry (312) from the first computer (A) to the second computer (B) if the processing time (T1) exceeds a standard time (TNORM), the method being characterised in that the standard time (TNORM) is dependent on the type of inquiry (311).

2. The method according to claim 1, wherein the standard time (TNORM) is dependent on the configuration of the first computer (A).

3. The method (400) according to claim 1, wherein the processing time (T1) is determined relative to a quantity of data.

4. The method according to claim 1, wherein the processing times of consecutive inquiries are taken into account during observation (410).

5. The method (400) according to claim 1 by using a management program (110/120) with the modules: observer (110) for observation (410) and rerouter (120) for rerouting (420).

6. The method (400) according to claim 1, wherein the steps of observation (410) and rerouting (420) are induced by a management program (110/120) within the system.

7. A computer program which is loaded on a computer and which induces a computer system to execute a method according to any one or more of claims 1 to 6.

8. A computer system (A, B) comprising at least one first computer (A) and one second computer (B) for processing consecutive inquiries (311, 312) from an external computer (E), wherein the computer system executes a method according to any one or more of claims 1 to 6.
